(19) United States
(12) Patent Application Publication
(10) Pub. No.: US 2024/0428315 A1
(43) Pub. Date: Dec. 26, 2024

(54) SUGGESTING FULFILLMENT SOURCES FOR A USER AT A NEW LOCATION BASED ON USER'S HISTORICAL ACTIVITY

(71) Applicant: Maplebear Inc. (dba Instacart), San Francisco, CA (US)

(72) Inventors: Sharath Rao Karikurve, Berkeley, CA (US); Ramasubramanian Balasubramanian, Jersey City, NJ (US)

(21) Appl. No.: 18/213,764

(22) Filed: Jun. 23, 2023

(51) Int. Cl. G06Q 30/0601

(52) U.S. Cl. CPC G06Q 30/0631; G06Q 30/0627; G06Q 30/0639

(57) ABSTRACT

An online system provides a platform for users to place orders at different physical retailers. When a user moves from one location to another (e.g., the user physically moves or is traveling), where the user's preferred retailer is not available, the online system suggests a new retailer for the user and optionally items to purchase at the new retailer. When a user accesses the online system from a new location, the system obtains the user's previous purchases and computes a repurchase probability. The system then ranks candidate new retailers in the new location based on their match to the likely repurchased items. To suggest new items to buy at the new retailer, the system uses existing replacement models to suggest replacements for the items that the user is likely to buy based on previous purchases.

### BACKGROUND

Customers purchase many of the same products from one or more retail stores on a regular basis. However, since different retailers do not necessarily carry the same items (e.g., brand, flavor, etc.), customers are often inconvenienced when they move residences or travel to a different city if their primary retailer is not available in their new location. As a result, they must go through an often-tedious process of manually searching out one or more retailers and replacing the items they used to buy from their preferred retailers at the previous location to items available at a new retailer at their new location.

This problem is also experienced by users who use an online concierge shopping system to obtain items from a retail location (which may be a brick and mortar store, a warehouse, or some other fulfillment source). In particular, a user placing an order using an online concierge shopping service typically selects a retailer location from which the user's order is to be fulfilled. The online concierge system then dispatches a shopper to obtain items from the order at the retailer location and then deliver the items to the user. If a user moves or is temporarily at a new location, the retailer locations used previously by the user may not be available at the new location. Accordingly, it would be helpful to recommend retail locations to a user who may not be familiar with the retail options in the new location.

### SUMMARY

In accordance with one or more aspects of the disclosure, an online concierge system provides a platform for users to place orders at different physical retailers. The concierge system maintains an item catalog for each of these retailers across many locations while also maintaining items purchased by users at these retailers. Each week these users purchase many of the same items and a probable list of items a user might purchase can be obtained. In response to receiving location information for the user at a new location, such as when the user opens their app associated with the concierge system in the new location, the system initiates a process for suggesting replacement items (or in some instances, at least one of the regularly purchased items) for the user to buy at a new retailer. This process includes the concierge system determining a repurchase probability for at least a subset of items purchased by the user, retrieving a set of retailers for the new location, and determining, for each retailer at the new location, an item similarity score between items purchased by the user and items carried by the corresponding retailer at the new location. A retailer similarity score is then determined using the similarity of items to identify a retailer most like the user's preferred retailer at their previous location. Accordingly, the retailer similarity score is determined for each retailer based on the item similarity score for the items purchased by the user weighted by the repurchase probability. The concierge system then provides a recommended list of retailers to the user ranked based on the retailer similarity score. Thus, the concierge system provides the user with a ranked list of retailers around their new location where they're most likely to be able to complete their regular shopping needs.

In response to receiving a selection of a retailer from the list of recommended retailers, the concierge system, in one or more embodiments, identifies a set of items at the new retailer using the item similarity score of each item and recommends this set of items for purchase to the user. This recommended set of items may include both replacement items and some of the same items that the user regularly purchased at their previous retailer. When the exact item is not available at the new retailer, the concierge system may provide a set of similar replacement items to allow the user to pick from among a number of available similar items. In one or more embodiments, the set of similar replacement items are ranked based on the item similarity score and a value score, where the value score is based on whether an item is currently associated with a deal, coupon, or discount.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a process flow diagram for ranking retailers at a new location for a user based on regular purchases of the user, in accordance with one or more embodiments.

FIG. 4 is a flowchart illustrating a method for ranking retailers at a new location for a user based on regular purchases of the user, in accordance with one or more embodiments.

FIG. 5 is a flowchart illustrating a method for ranking items at a selected retailer in a new location for a user based on regular purchases of the user, in accordance with one or more embodiments.

### DETAILED DESCRIPTION

### Overview

An online concierge system provides a platform for users to place orders at different physical retailers. Each week users of the platform purchase many of the same items from one or more retailers and, with this information, a list of items a user might buy during a shopping trip (whether through online concierge system or in store) can be obtained. Once a user opens their app associated with the online concierge system in a new location, the online concierge system can recommend retailers near their current location. Accordingly, once the user picks a retailer, the online concierge system recommends items at that retailer that map to what they normally purchase. Thus, the online concierge system obtains the current location of the user (at a new location) and returns a ranked list of retailers that would be a good match for them.

To achieve this, the online concierge system predicts a repurchase probability to assign a weight to each item that the user purchased over a recent period of time (e.g., past 3 months). In one or more embodiments, the online concierge system uses product embeddings stored for each product available in the store to retrieve a set candidate product at least similar to each product in the user's past purchases using an approximate nearest neighbor search. The search may yield one or more of the same items that the user usually purchases if they are available. The online concierge system may then filter out candidate products that are not available (or low in stock) at the new retailer and the remaining candidates are ranked according to their embedding similarity to those in the user's past purchases. Then, with the topmost similar items (or best matches), an average similarity score is determined and used as the measure of there being an item similar enough to the user's preferred item in the store. The stores are then ranked based on a weighted average of the similarity score, weighted by the repurchase probability of each item.

Once the user selects a retailer to shop from at their new location, the concierge system identifies a set of items at the new retailer using the item similarity score of each item and recommends a set of items for purchase to the user. While recommending items, the online concierge system may optimize for different things, such as for incrementality or for providing additional reach to emerging brands. Accordingly, this recommended set of items may include replacement items, newly recommended items, or some of the same items that the user regularly purchased at their previous retailer.

### Example System

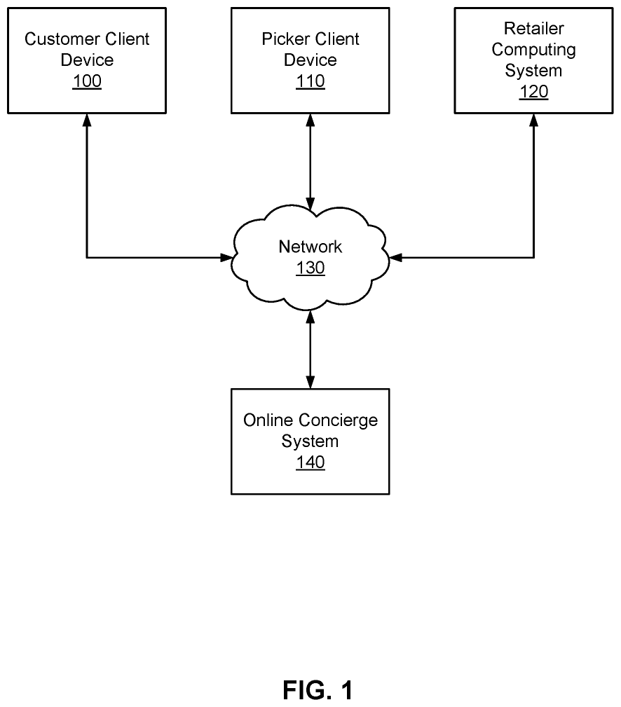

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi or fully autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

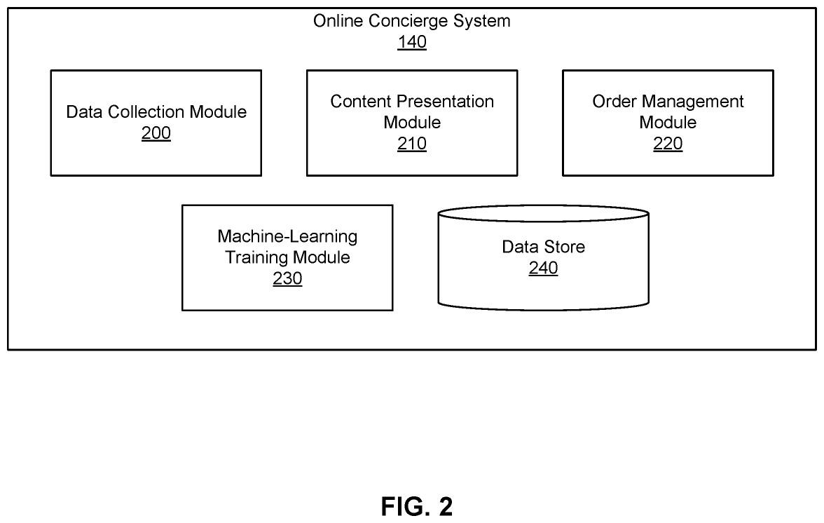

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

### Example Concierge System

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, item purchase history, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location, such as an item catalog for the retailer. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

The content presentation module 210 may also use a replacement model to score items for presentation to a customer. In various embodiments, the replacement model is a sub model of the item selection model. The replacement model maps items that a user regularly buys to replacements when one or more of those items are unavailable or stock is low. The replacement model, in one or more embodiments, may also be used to identify one or more items that a customer has purchased (or regularly purchases) at first retailer to one or more items available at a second retailer. One or more embodiments of the replacement model is further described in U.S. patent application Ser. No. 17/196,855; U.S. patent application Ser. No. 17/069,741; and U.S. patent application Ser. No. 18/113,965, each of which is incorporated by reference herein in its entirety.

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

Order management module 220 coordinates payment by the customer for the order. Order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, retailer data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

### Example Process Flow for Ranking Retailers for a User at a New Location

Concierge system 140 provides a platform for users to place orders at different physical retailers. As described above, concierge system 140 maintains an item catalog for each of these retailers across many locations while also maintaining items purchased by users at these retailers. Each week these users purchase many of the same items and a probable list of items a user might purchase can be obtained. Thus, once a user opens the concierge system app on their phone or mobile device in a new location (different from their home location), online concierge system 140 can recommend retailers near their current location. Accordingly, once the user picks a retailer, the online concierge system recommends items at that retailer that map to what the user normally purchases. Thus, the online concierge system 140 obtains the current location of the user (at a new location) and returns a ranked list of retailers that would be a good match.

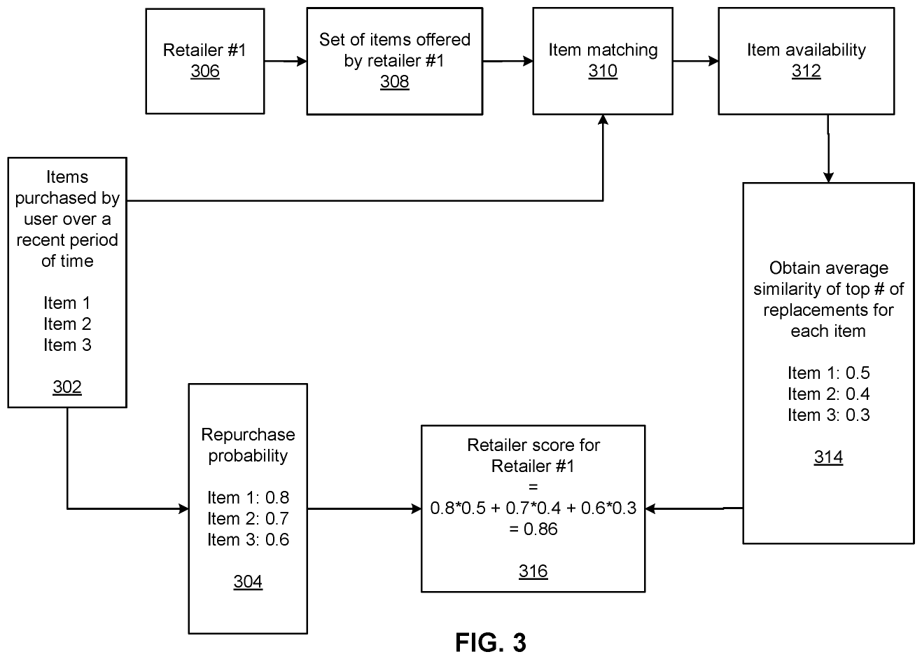

FIG. 3 illustrates a process flow diagram for ranking retailers at a new location for a user, in accordance with one or more embodiments. Concierge system 140 tracks items purchased by the user and identifies 302 at least a subset of those items. A subset is used to denote that the user's most relevant purchases have likely taken place over a recent period of time (e.g., last 1-3 months); however, concierge system 140 could look at all items purchased by the user. Additionally, these items could be all items purchased by the user over that period or some subset of the items based on item category or type, such as repeatedly purchased items, staples that are associated with purchases of regular cadence (e.g., butter, paper towels, etc.), and so forth. In this example, concierge system 140 identifies 3 items: item 1, item 2, and item 3; however, there can be many more than three items used in this determination.

Concierge system 140 then determines 304 a repurchase probability for each of these identified items. The repurchase probability is determined using a repurchase probability model that, in one or more embodiments, may take the item, item characteristics, and number of times the item has been purchased as input and outputs a probability of the user purchasing that item again. In this example, the repurchase probability for item 1 is 0.8, the repurchase probability for item 2 is 0.7, and the repurchase probability for item 3 is 0.6.

Concierge system 140 then retrieves a set of retailers 306 for the new location and, for each retailer, concierge system first determines an item similarity score. For simplicity, FIG. 3 shows a single retailer #1; however, there are a number of candidate retailers for a given location (otherwise, there would be no need to rank them) and the item similarity score (and eventual retailer similarity score) is calculated for each retailer.

As described above, concierge system 140 maintains an item catalog for retailers in many locations and obtains a set of items offered by each retailer in the new location. Thus, in this example, concierge system 140 obtains 308 a set of items offered by retailer #1.

Concierge system 140 matches 310 items purchased by the user with items carried by the corresponding retailer at the new location. In this example, concierge system 140 matches item 1, item 2, and item 3 to the items stored in the item catalog for retailer #1. In one or more embodiments, concierge system 140 uses item embeddings stored for every product available at retailer #1 to identify replacement items that are at least similar to each item in the user's past purchases using approximate nearest neighbor (ANN) search. ANN search compares embeddings and returns a similarity score for each item. The search may yield an identical item available at retailer #1, such as the same brand of whitening toothpaste that the user usually purchases at their preferred retailer in their home location. In this instance, the similarity score for identical items is 1. However, if the identical item is not available at retailer #1, the ANN search returns a value for each item that ranges from 0-0.99. For example, a different brand of whitening toothpaste may yield a 0.90 similarity score (e.g., Crest vs. Colgate) and a different brand of non-whitening toothpaste may yield a 0.80 similarity score. Accordingly, for non-identical items, concierge system 140 identifies a top number of replacement items (e.g., 3-5) that are similar to the item that user usually buys to enable the user to pick from among a number of available similar items offered by retailer #1. Since these are not identical items, concierge system 140 may identify the items with the highest 3-5 similarity scores returned from the ANN search instead of merely identifying a single item with the highest similarity score.

Concierge system 140 determines 312 the item availability of the items returned in the search and removes those that are low in stock or unavailable from consideration so that they do not factor into the retailer similarity score determination.

Concierge system 140 obtains 314 the average similarity score for top few replacement items with the highest similarity scores that are available at retailer #1. Continuing with the toothpaste example, if whitening toothpaste brand #1 has a similarity score 0.9, non-whitening toothpaste brand #1 has a similarity score 0.8, and sensitive toothpaste brand #2 has a similarity score of 0.5, the average similarity score of this item is (0.9+0.8+0.5)/3=0.73. Referring to FIG. 3, the average similarity score of the replacements for item 1 is 0.5, item 2 is 4.0, and item 3 is 0.3. In one or more embodiments, the average similarity score is computed for identical items. For example, if the similarity scores are 1.0, 0.8, and 0.5 for the top 3 replacements and 1.0 refers to the identical item, the average similarity score would be calculated as (1.0+0.8+0.5)/3=0.77. Alternatively, the average similarity score need not be calculated for items with an identical replacement at the new retailer and an average similarity score of 1.0 could be used at step 314.

Concierge system 140 determines 316 a retailer similarity score using the similarity of items to identify a retailer where the user will be most likely to fulfill their shopping needs in the new location. The retailer similarity score is determined for each retailer as a sum of the similarity scores weighted by their corresponding repurchase probability. As shown in FIG. 3, the retailer score for retailer #1 is (0.8*0.5)+ (0.7*0.4)+ (0.6*0.3)=0.86. Accordingly, concierge system 140 ranks the retailers based on their retailer score and provides them to the user. Thus, the concierge system provides the user with a ranked list of retailers around their new location where they're most likely to be able to complete their regular shopping needs.

Once the user selects a retailer from the ranked list, concierge system 140 recommends items similar to those that the user normally purchases. In one or more embodiments, concierge system 140 notifies the users that the items they normally purchase at their normal retailer have been mapped to a set of most similar items at the new selected retailer. They may also be asked to select items from their original retailer that they would like to purchase and, in response, be presented with a set of items similar to those they selected. In one or more embodiments, for each item, concierge system 140 can present a list of multiple items (e.g., 3-10) in the user's app ranked according to a process similar to how the items were selected above, e.g., for each item the user selects, concierge system 140 performs an ANN based retrieval using the item embeddings to obtain similarity scores; and filters out the candidates that are not in stock (or are low stock) to obtain a set of items to recommend.

In one or more embodiments, a value_score is added to the similarity score to boost the ranking of a particular item (e.g., similarity score=a*similarity_score+b*value_score, where a and b are tunable constants). The value_score could be a simple binary 0 or 1 based on whether the item is currently associated with a deal, coupon, or discount or the value_score could be a score based on a percentage of a discount associated with the item. Additionally, a price sensitivity model could be used to tune the weights of the value_score for customers more sensitive to price changes and discounts could be scored higher (or alternatively, the value score term could be price_sensitivity_score*value_score). In other embodiments, the value_score is based on the item's price, or a comparison of the price to an average price of an item category to which the item belongs, and is therefore reflective of a “good” deal for the item regardless of whether a coupon or other discount is applied. Concierge system 140 then ranks the filtered candidates based on the aforementioned formula that includes the value_score and presents those items to the user.

In one or more embodiments, concierge system 140 generates a global list of recommendations for the user. Thus, instead of asking the user to select an item from their preferred retailer and concierge system 140 mapping those items to a list of items at the new retailer (as described above), concierge system 140 performs a process similar to that described above for determining the retailer similarity scores. In particular, concierge system 140 identifies a set of items purchased by the user over a recent period of time (e.g., past 3 months); retrieves similar items at the new retailer using ANN embedding based search; filters out items that are low in stock or are not available; and ranks items based on their repurchase probability and item similarity score. Accordingly, an example formula for ranking the items for the user could be repurchase_probability*(a*similarity_score+b*price_sensitivity_score*value_score).

In one or more embodiments, concierge system 140 could impose a diversity penalty to remove items that are too similar to each other when making recommendations to the user. For example, if milk has a repurchase probability of 1 and there are 10 milk products at the new retailer that all have high similarity scores with the user's preferred milk item, the user would be shown 10 redundant items. This is not a good user experience. In one or more embodiments, a heuristic is imposed to prevent a potential replacement for the same product within 3 positions of another from being presented to the user. Alternatively, another term could be added to the score determination formula that accounts for the number of similar items corresponding to the preferred item that have already been shown and which reduces the score accordingly (e.g., −1*c*number_of_similar_products_previous_shown).

### Method for Ranking Retailers for a User at a New Location

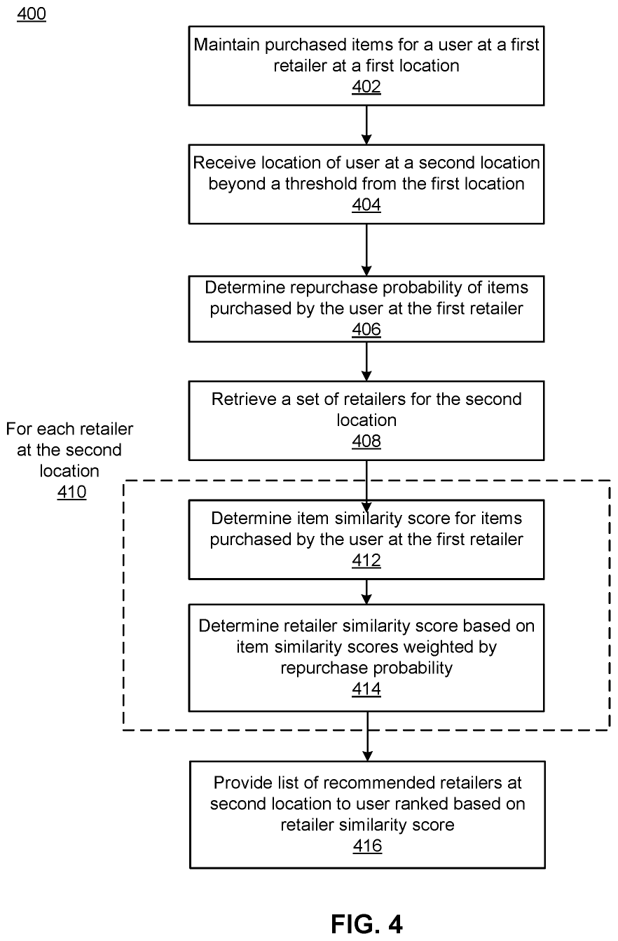

FIG. 4 is a flowchart illustrating a method 400 for ranking retailers at a new location for a user based on the user's regular purchases, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., online concierge system 140). Additionally, each of these steps may be performed automatically by the online concierge system without human intervention.

Concierge system 140 maintains 402 purchased items for a user at a first retailer at a first location. The first retailer, in one or more embodiments, is the user's preferred retailer or where they do much of their shopping in their home location. Thus, in this example, the first location is the user's home location.

Concierge system 140 receives 404 location information of the user at a second location beyond a threshold distance from the first location. Thus, once a user opens the concierge system app on their phone or mobile device in a new location (different from their home location), online concierge system 140 can recommend retailers near their current location. In this example, the second location is one which the user has traveled to that is far enough away from their home location that shopping at their preferred retailer (i.e., the first retailer) is not practical. Accordingly, in determining that the user is beyond at least a threshold distance from their preferred retailer or home location, concierge system 140 initiates a process to recommend similar retailers in the user's new location where they can meet their regular shopping needs (i.e., those that they usually fulfill at the first retailer).

In one or more embodiments, concierge system 140 may first determine whether their first retailer is available at the second location. For example, if the first retailer is a chain store with multiple locations and, based on the received location information for the user, concierge system 140 determines that the first retailer has a location within a reasonable distance (i.e., within a threshold distance) of the user's current location, concierge system 140 may default to presenting items to the user at this retailer. Thus, in order to initiate the process of recommending a retailer to the user in a new location, concierge system 140 may require that two conditions are met i.e., that the user is beyond a threshold distance from their preferred retailer (or home location) and that the user's preferred retailer is not available at their new location.

Concierge system determines 406 a repurchase probability for items purchased by the user at the first retailer. The repurchase probability can be determined using a probability model that, in one or more embodiments, may take the item, item characteristics, and number of times the item has been purchased by the user as input and outputs a probability of the user purchasing that item again. The repurchase probability may be calculated for all the user's purchases at the first retailer, a subset of all purchases based on time (e.g., past 1-3 months), or a subset based on item type, such as staple items that are purchased at a regular cadence (e.g., toothpaste, butter, milk, etc.) as opposed to an item users buy much more infrequently (e.g., televisions, computers, etc.).

Concierge system 140 retrieves 408 a set of retailers for the second location. These are retailers within a threshold distance of the user's current location for which concierge system 140 will evaluate for their similarity to the user's preferred retailer.

Accordingly, for each retailer 410 at the second location, concierge system 140 determines 412 an item similarity score for items purchased by the user at the first retailer. As described above, this could be all items purchased by the user or a subset. In one or more embodiments, concierge system 140 uses item embeddings stored for every product available at each retailer at the second location to identify items at least similar to the items purchased by the users using an ANN search. In one or more embodiments, the embedding for each item is based on a two-tower model that takes in an item sentence that includes at least two of a name of the item, a brand of the item, taxonomy information, item flavor, item size, or other identifying information. As described above, the ANN search compares embeddings and returns a similarity score for each item. The search may yield an identical item available at one or more retailers, such as the same brand of butter that the user usually purchases at their preferred retailer in their home location. In such an instance, the similarity score for an identical item could be 1. However, if the identical item is not available at a retailer, the ANN search may return a value for the item that ranges between 0-0.99 depending on how similar the item is to that that the user has previously purchased. Accordingly, for non-identical items, concierge system 140 may identify a top number of replacement items that are similar to the item that user usually buys to determine an average similarity score for the item used to rank the retailer. Since these are not identical items, concierge system 140 may identify the items with the highest similarity scores returned from the ANN search.

Concierge system 140 determines 414 a retailer similarity score for each retailer at the second location based on the retailer's corresponding item similarity scores weighted by the item's repurchase probability. In one or more embodiments, the retailer similarity score is a sum of the similarity scores weighted by their corresponding repurchase probability.

Concierge system provides 416 a list of recommended retailers to the user for the second location that are ranked based on retailer similarity score. Thus, the concierge system provides the user with a ranked list of retailers around their new location where they're most likely to be able to complete their regular shopping needs. Once the user selects a retailer from the ranked list, concierge system 140 recommends items similar to those that the user normally purchases, as described in more detail below.

### Method for Ranking Items at a Selected Retailer for a User at a New Location

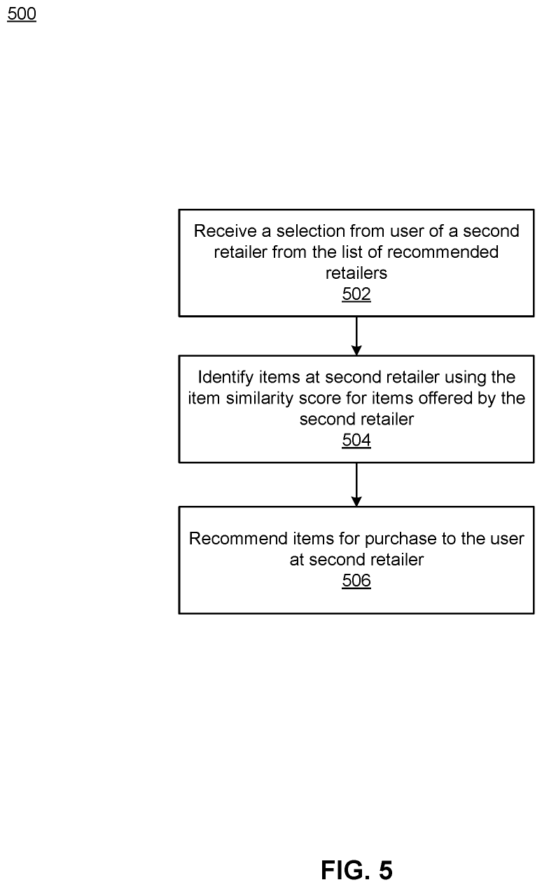

FIG. 5 is a flowchart illustrating a method 500 for ranking items at a selected retailer in a new location for a user based on regular purchases of the user, in accordance with one or more embodiments.

After presenting the user with a list of recommended retailers near their current location, concierge system 140 receives 502 a selection from the user of a second retailer from the list. In one or more embodiments, the list is presented to the user on their mobile device or smartphone via an app associated with concierge system 140 but may also be presented via webpage of the concierge system 140 on a personal computer.

In response to receiving the selection, concierge system 140 identifies 504 items at the second retailer using the item similarity score for items offered by the second retailer. In one or more embodiments, concierge system 140 notifies the users that the items they normally purchase at their normal retailer have been mapped to a set of most similar items at the new selected retailer. They may also be asked to select items from their original retailer that they would like to purchase and, in response, be presented with a set of items similar to those they selected. In one or more embodiments, for each item, concierge system 140 presents a list of multiple items ranked according to a process similar to how the items were selected above, e.g., for each item the user selects, concierge system 140 performs an ANN based search using item embeddings to obtain similarity scores; and filters out the candidates that are not in stock (or are low stock) to obtain a set of items to recommend.

Alternatively, concierge system 140 may generate a global list of recommendations for the user. Thus, instead of asking the user to select an item from their preferred retailer for concierge system 140 to map those items to a list of items at the new retailer, concierge system 140 may automatically perform a process similar to that described above for determining the retailer similarity scores, i.e., concierge system 140 identifies a set of items purchased by the user; retrieves similar items at the new retailer using ANN embedding based search; filters out items that are low in stock or are not available; and ranks items based on their repurchase probability and item similarity score.

Accordingly, concierge system 140 recommends 506 items for the user to purchase at the second retailer that are at least similar to those that they regularly purchase at their home retailer. In one or more embodiments, concierge system 140 provides the user with a map of the second retailer that identifies a location of each recommended item within the second retailer.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
maintaining, by a concierge system, an item catalog for each of a plurality of retailers at a plurality of locations;
maintaining, by the concierge system, purchased items for a user at a first retailer of the plurality of retailers at a first location;
receiving location information for the user at a second location, wherein the second location is beyond a threshold distance from the first location; and
responsive to receiving the location information for the user at the second location:
determining a repurchase probability for each item in a set of purchased items, wherein the set of purchased items is at least a portion of the purchased items maintained for the user by the concierge system;
retrieving a set of retailers for the second location;
for each retailer at the second location,
determining an item similarity score for each item in the set of purchased items purchased by the user at the first retailer; and
determining a retailer similarity score based on each item similarity score weighted by the corresponding repurchase probability;
ranking a list of recommended retailers at the second location based on the retailer similarity scores; and
sending the ranked list of recommended retailers to a device of the user, wherein sending causes the device of the user to display the ranked list of recommended retailers.

2. The method of claim 1, further comprising:
receiving a selection of a second retailer from the list of recommended retailers; and
responsive to receiving the selection of the second retailer from the list of recommended retailers:
identifying a set of items at the second retailer using the item similarity score for items offered by the second retailer; and
recommending the set of items for purchase to the user.

3. The method of claim 2, further comprising:
responsive to receiving the selection of the second retailer from the list of recommended retailers, causing the device of the user to display a map of the second retailer that identifies a location of each recommended item within the second retailer.

4. The method of claim 2, wherein the identified set of items at the second retailer includes a set of replacement items for at least one of the set of purchased items purchased by the user at the first retailer to enable the user to pick from among a number of available similar items offered by the second retailer.

5. The method of claim 4, wherein the set of replacement items are ranked based on the item similarity score and a value score, and wherein the value score is a binary value based on whether an item is currently associated with a deal, coupon, or discount.

6. The method of claim 1, wherein the item similarity score is determined by performing an approximate nearest neighbor search using an embedding for each item in the set of purchased items purchased by the user at the first retailer and embeddings of items in the item catalog of each retailer of the set of retailers at the second location.

7. The method of claim 6, wherein the embedding for each item is based on a two-tower model that takes in an item sentence that includes at least two of: a name of the item, a brand of the item, taxonomy information, item flavor, or item size.

8. The method of claim 1, wherein the set of retailers at the second location is retrieved further based on determining that the first retailer is not available at the second location.

9. The method of claim 1, further comprising:
removing, for each retailer in the set of retailers at the second location, items that are low in stock below a threshold or unavailable from inclusion into the retailer similarity score determination.

10. The method of claim 1, wherein the item similarity score is an average of two or more scores for replacement items at the corresponding retailer for each item in the set of purchased items purchased by the user at the first retailer that is not available at the corresponding retailer.

11. A non-transitory computer-readable medium method storing instructions that, when executed by a processor, cause the processor to perform steps comprising:
maintaining, by a concierge system, an item catalog for each of a plurality of retailers at a plurality of locations;
maintaining, by the concierge system, purchased items for a user at a first retailer of the plurality of retailers at a first location; and
receiving location information for the user at a second location, wherein the second location is beyond a threshold distance from the first location; and
responsive to receiving the location information for the user at the second location:
determining a repurchase probability for each item in a set of purchased items, wherein the set of purchased items is at least a portion of the purchased items maintained for the user by the concierge system;
retrieving a set of retailers for the second location;
for each retailer at the second location,
determining an item similarity score for each item in the set of purchased items purchased by the user at the first retailer; and
determining a retailer similarity score based on each item similarity score weighted by the corresponding repurchase probability;
ranking a list of recommended retailers at the second location based on the retailer similarity scores; and
sending the ranked list of recommended retailers to a device of the user, wherein sending causes the device of the user to display the ranked list of recommended retailers.

12. The non-transitory computer-readable medium of claim 11, wherein the instructions that, when executed by the processor, further cause the processor to perform steps comprising:
receiving a selection of a second retailer from the list of recommended retailers; and
responsive to receiving the selection of the second retailer from the list of recommended retailers:
identifying a set of items at the second retailer using the item similarity score for items offered by the second retailer; and
recommending the set of items for purchase to the user.

13. The non-transitory computer-readable medium of claim 12, wherein the instructions that, when executed by the processor, further cause the processor to perform steps comprising:
responsive to receiving the selection of the second retailer from the list of recommended retailers, causing the device of the user to display a map of the second retailer that identifies a location of each recommended item within the second retailer.

14. The non-transitory computer-readable medium of claim 12, wherein the identified set of items at the second retailer includes a set of replacement items for at least one of the set of purchased items purchased by the user at the first retailer to enable the user to pick from among a number of available similar items offered by the second retailer.

15. The non-transitory computer-readable medium of claim 14, wherein the set of replacement items are ranked based on the item similarity score and a value score, and wherein the value score is a binary value based on whether an item is currently associated with a deal, coupon, or discount at item similarity score determination.

16. The non-transitory computer-readable medium of claim 11, wherein the item similarity score is determined by performing an approximate nearest neighbor search using an embedding for each item in the set of purchased items purchased by the user at the first retailer and embeddings of items in the item catalog of each retailer of the set of retailers at the second location.

17. The non-transitory computer-readable medium of claim 11, wherein the set of retailers for the second location is retrieved further based on determining that the first retailer is not available at the second location.

18. The non-transitory computer-readable medium of claim 11, wherein the instructions that, when executed by the processor, further cause the processor to perform steps comprising:
removing, for each retailer in the set of retailers at the second location, items that are low in stock below a threshold or unavailable from inclusion into the retailer similarity score determination.

19. The non-transitory computer-readable medium of claim 11, wherein the item similarity score is an average of two or more replacement items at the corresponding retailer for each item in the set of purchased items purchased by the user at the first retailer that is not available at the corresponding retailer.

20. A computer system comprising:
a computer processor; and
a non-transitory computer-readable medium comprising instructions that, when executed by the processor, cause the processor to perform steps comprising:
maintaining, by a concierge system, an item catalog for each of a plurality of retailers at a plurality of locations;
maintaining, by the concierge system, purchased items for a user at a first retailer of the plurality of retailers at a first location; and
receiving location information for the user at a second location, wherein the second location is beyond a threshold distance from the first location; and
responsive to receiving the location information for the user at the second location,
determining a repurchase probability for each item in a set of purchased items, wherein the set of purchased items is at least a portion of the purchased items maintained for the user by the concierge system;
retrieving a set of retailers for the second location;
for each retailer at the second location,
determining an item similarity score for each item in the set of purchased items purchased by the user at the first retailer; and
determining a retailer similarity score based on each item similarity score weighted by the corresponding repurchase probability;
ranking a list of recommended retailers at the second location based on the retailer similarity scores; and
sending the ranked list of recommended retailers to a device of the user, wherein sending causes the device of the user to display the ranked list of recommended retailers.
